(19) United States
(12) Patent Application Publication
(10) Pub. No.: US 2023/0363382 A1
(43) Pub. Date: Nov. 16, 2023

(54) COMBINATIONS OF TRIAZINONE HERBICIDES WITH SAFENERS

(71) Applicants: UPL DO BRASIL INDUSTRIA E COMERCIO DE INSUMOS AGROPECUARIOS S.A., Ituverava (BR); UPL Corporation Limited, Port Louis (MU)

(72) Inventors: Giuvan Lenz, Ituverava (BR); Ferdinando Marcos Lima Silva, Ituverava (BR)

(21) Appl. No.: 18/028,614

(22) PCT Filed: Sep. 27, 2021
(86) PCT No.: PCT/BR2021/050412

§ 371 Date: Mar. 27, 2023

(30) Foreign Application Priority Data
Sep. 28, 2020 (BR) 102020019865-3

(51) Int. Cl. A01N 25/32; A01N 43/707; A01P 13/00

(52) U.S. Cl. CPC A01N 25/32; A01N 43/707; A01P 13/00

(57) ABSTRACT

The present invention describes a combination for the selective control of weeds, more particularly, the present invention relates to a combination of one or more triazinone herbicides with one or more safeners for the selective control of weeds.

### FIELD OF THE INVENTION

The present invention relates to a combination for the selective control of weeds. More particularly, the present invention relates to a combination of one or more triazinone herbicides with one or more safeners for the selective control of weeds.

### BACKGROUND OF THE INVENTION

Some very effective herbicides i.e. herbicides that exhibit highly effective weed control exhibit toxicity on the crop itself along with weeds. In other words, they exhibit non selective control of weeds to be eliminated. This is also the case with Triazinone herbicides such as Amibuzin, Hexazinone, Metamitron, Metribuzin, Isomethiozin, Ipfencarbazone and Ametridione that exhibit excellent weed control but at the cost of damage to crop itself. Sometimes this undesired effect on the crop can be so devastating that whole crop gets wiped out. In such cases, phytotoxicity is said to be 100%. Other instances of unwanted effects of herbicides on crops are lesser plant height or lesser number of plants standing after herbicidal treatments.

Triazinone herbicides cover herbicides that act by different modes of action. Ipfencarbazone that acts by inhibiting very long-chain fatty acid (VLCFA) synthesis, Amibuzin, Hexazinone, Metamitron, Metribuzin, Isomethiozin, and Ametridione that act by inhibiting photosynthesis II are examples of Triazinone herbicides. Photosynthesis II inhibitors act by blocking electron transport and stopping CO2 fixation and production of energy and by causing lipid and protein membrane destruction. VLCFA inhibitors cause preventing of emergence of shoot from the coleoptile or whorl of the grass and cause enlarged cotyledons, restricted growth of the true leaves, dark green color, and stunting of broadleaf plants.

IUPAC name of Amibuzin is 6-tert-butyl-3-dimethylamino-4-methyl-1,2,4-triazin-5(4H)-one.

IUPAC name of Hexazinone is 3-cyclohexyl-6-dimethylamino-1-methyl-1,3,5-triazine-2,4(1H,3H)-dione.

IUPAC name of Metamitron is 4-amino-4,5-dihydro-3-methyl-6-phenyl-1,2,4-triazin-5-one.

IUPAC name of Metribuzin is 4-amino-6-tert-butyl-4,5-dihydro-3-methylthio-1,2,4-triazin-5-one.

IUPAC name of Isomethiozin is 6-tert-butyl-4-isobutylideneamino-3-methylthio-1,2,4-triazin-5(4H)-one.

IUPAC name of Ipfencarbazone is 1-(2,4-dichlorophenyl)-2′,4′-difluoro-1,5-dihydro-N-isopropyl-5-oxo-4H-1,2,4-triazole-4-carboxanilide.

IUPAC name of Ametridione is 1-amino-6-ethylthio-3-neopentyl-1,3,5-triazine-2,4(1H,3H)-dione.

Chemical agents called as safeners, when used with herbicides, act as their antidotes and make use of the herbicides safer. However, it is pertinent to note that not all the safeners work well with all the herbicides. Scientists are always faced with the challenge of finding safener herbicide combinations that work well.

There is therefore a need in the art for safener combinations with triazinone herbicides that reduce their phytotoxicity, result in increased plant height and/or increased number of plants standing after herbicidal treatment.

### OBJECTS OF THE INVENTION

The present invention, described hereinafter, achieves at least one of the following objects of the invention.

It is an object of the present invention to provide combinations of one or more triazinone herbicides with one or more safeners.

It is an object of the present invention to provide combinations of triazinone herbicides with one or more safeners, wherein triazinone herbicides are selected from one or more of Amibuzin, Hexazinone, Metamitron, Metribuzin, Isomethiozin, Ipfencarbazone and Ametridione.

It is an object of the present invention to provide combinations of triazinone herbicides with one or more safeners, wherein triazinone herbicides are selected from one or more of Amibuzin, Hexazinone, Metamitron, Metribuzin, Isomethiozin, Ipfencarbazone and Ametridione and said combinations exhibit less or no phytotoxicity.

It is an object of the present invention to provide combinations of triazinone herbicides with one or more safeners, wherein triazinone herbicides are selected from one or more of Amibuzin, Hexazinone, Metamitron, Metribuzin, Isomethiozin, Ipfencarbazone and Ametridione and said combinations result in increased plant height.

It is an object of the present invention to provide combinations of triazinone herbicides with one or more safeners, wherein triazinone herbicides are selected from one or more of Amibuzin, Hexazinone, Metamitron, Metribuzin, Isomethiozin, Ipfencarbazone and Ametridione and said combinations result in increased number of plants standing after treatment.

It is an object of the present invention to provide combinations of triazinone herbicides with one or more safeners, wherein triazinone herbicides are selected from one or more of Amibuzin, Hexazinone, Metamitron, Metribuzin, Isomethiozin, Ipfencarbazone and Ametridione and said combinations exhibit less or no phytotoxicity, result in increased plant height and/or increased number of plants standing after treatment, preferably in corn, wheat, barley, rye, oats, rice, soybean, cotton, canola, sugar beet, potatoes, tobacco, and oil seed rape, more preferably in soybean.

### SUMMARY OF THE INVENTION

In an aspect, present invention provides combinations of one or more triazinone herbicides with one or more safeners.

In an aspect, present invention provides combinations of one or more triazinone herbicides with one or more safeners, wherein triazinone herbicides are selected from one or more of Amibuzin, Hexazinone, Metamitron, Metribuzin, Isomethiozin, Ipfencarbazone and Ametridione.

In an aspect, present invention provides combinations of triazinone herbicides with one or more safeners, wherein triazinone herbicides are selected from one or more of Amibuzin, Hexazinone, Metamitron, Metribuzin, Isomethiozin, Ipfencarbazone and Ametridione and said combinations exhibit less or no phytotoxicity.

In an aspect, present invention provides combinations of triazinone herbicides with one or more safeners, wherein triazinone herbicides are selected from one or more of Amibuzin, Hexazinone, Metamitron, Metribuzin, Isomethiozin, Ipfencarbazone and Ametridione and said combinations result in increased plant height.

In an aspect, present invention provides combinations of triazinone herbicides with one or more safeners, wherein triazinone herbicides are selected from one or more of Amibuzin, Hexazinone, Metamitron, Metribuzin, Isomethiozin, Ipfencarbazone and Ametridione and said combinations result in increased number of plants standing after treatment.

In an aspect, present invention provides combinations of triazinone herbicides with one or more safeners, wherein triazinone herbicides are selected from one or more of Amibuzin, Hexazinone, Metamitron, Metribuzin, Isomethiozin, Ipfencarbazone and Ametridione and said combinations exhibit less or no phytotoxicity, result in increased plant height and/or increased number of plants standing after treatment, preferably in corn, wheat, barley, rye, oats, rice, soybean, cotton, canola, sugar beet, potatoes, tobacco, and oil seed rape, more preferably in soybean.

In an aspect, present invention provides combinations of one or more triazinone herbicides with safeners wherein safeners are selected from one or more of Mefenpyr-diethyl, Isoxadifen-ethyl, Cloquintocet-mexyl, Dichlormid, Benoxacor, Flurazole and Fluxofenim.

In an aspect, present invention provides combinations of triazinone herbicides with one or more safeners wherein triazinone herbicides are selected from one or more of Amibuzin, Hexazinone, Metamitron, Metribuzin, Isomethiozin, Ipfencarbazone and Ametridione and said combinations are applied preferably to corn, wheat, barley, rye, oats, rice, soybean, cotton, canola, sugar beet, potatoes, tobacco, and oil seed rape, more preferably to soybean directly or soil in which their seeds are sown.

In an aspect, present invention provides combinations of one or more triazinone herbicides with one or more safeners selected from Mefenpyr-diethyl, Isoxadifen-ethyl, Cloquintocet-mexyl, Dichlormid, Benoxacor, Flurazole and Fluxofenim and said combinations are applied preferably to corn, wheat, barley, rye, oats, rice, soybean, cotton, canola, sugar beet, potatoes, tobacco, and oil seed rape, more preferably to soybean directly or soil in which their seeds are sown.

In an aspect, present invention provides combinations of Metribuzin and one or more safeners selected from Mefenpyr-diethyl, Isoxadifen-ethyl, Cloquintocet-mexyl, Dichlormid, Benoxacor, Flurazole and Fluxofenim.

In an aspect, present invention provides combinations of Metribuzin and one or more safeners selected from Mefenpyr-diethyl, Isoxadifen-ethyl, Cloquintocet-mexyl, Dichlormid, Benoxacor, Flurazole and Fluxofenim and said combinations are applied preferably to corn, wheat, barley, rye, oats, rice, soybean, cotton, canola, sugar beet, potatoes, tobacco, and oil seed rape, more preferably to soybean directly or soil in which their seeds are sown.

### DETAILED DESCRIPTION OF INVENTION

As used herein, the term “control” includes controlling a pest, i.e. killing, also protecting a plant, or seed from attack or invasion by said pest.

It has surprisingly been found by the present inventors that combination of one or more triazinone herbicides with one or more safeners selectively controls weeds. Selective weed control was also accompanied by increased plant growth and increased number of plants standing after treatments. Treatments with one or more triazinone herbicides alone resulted in phytotoxicity, lesser plant height and lesser number of plants standing after treatments. Selective weed control, increased plant growth and increased number of plants stranding after treatments with combination of one or more triazinone herbicides with one or more safeners were unexpected.

In one embodiment, present invention provides combinations of one or more triazinone herbicides with one or more safeners.

In another embodiment, present invention provides combinations of one or more triazinone herbicides with one or more safeners, wherein triazinone herbicides are selected from one or more of Amibuzin, Hexazinone, Metamitron, Metribuzin, Isomethiozin, Ipfencarbazone and Ametridione.

In still another embodiment, present invention provides combinations of triazinone herbicides with one or more safeners, wherein triazinone herbicides are selected from one or more of Amibuzin, Hexazinone, Metamitron, Metribuzin, Isomethiozin, Ipfencarbazone and Ametridione and said combinations exhibit less or no phytotoxicity.

In still another embodiment, present invention provides combinations of triazinone herbicides with one or more safeners, wherein triazinone herbicides are selected from one or more of Amibuzin, Hexazinone, Metamitron, Metribuzin, Isomethiozin, Ipfencarbazone and Ametridione and said combinations result in increased plant height.

In still another embodiment, present invention provides combinations of triazinone herbicides with one or more safeners, wherein triazinone herbicides are selected from one or more of Amibuzin, Hexazinone, Metamitron, Metribuzin, Isomethiozin, Ipfencarbazone and Ametridione and said combinations result in increased number of plants standing after herbicidal treatments.

In still another embodiment, present invention provides combinations of triazinone herbicides with one or more safeners, wherein triazinone herbicides are selected from one or more of Amibuzin, Hexazinone, Metamitron, Metribuzin, Isomethiozin, Ipfencarbazone and Ametridione and said combinations exhibit less or no phytotoxicity, result in increased plant height and/or increased number of plants standing after herbicidal treatments, preferably in corn, wheat, barley, rye, oats, rice, soybean, cotton, canola, sugar beet, potatoes, tobacco, and oil seed rape, more preferably in soybean.

In still another embodiment, present invention provides combinations of one or more triazinone herbicides with safeners wherein safeners are selected from one or more of Mefenpyr-diethyl, Isoxadifen-ethyl, Cloquintocet-mexyl, Dichlormid, Benoxacor, Flurazole and Fluxofenim.

In still another embodiment, present invention provides combinations of triazinone herbicides with one or more safeners wherein triazinone herbicides are selected from one or more of Amibuzin, Hexazinone, Metamitron, Metribuzin, Isomethiozin, Ipfencarbazone and Ametridione and said combinations are applied preferably to corn, wheat, barley, rye, oats, rice, soybean, cotton, canola, sugar beet, potatoes, tobacco, and oil seed rape, more preferably to soybean directly or soil in which their seeds are sown.

In still another embodiment, present invention provides combinations of one or more triazinone herbicides with one or more safeners selected from Mefenpyr-diethyl, Isoxadifen-ethyl, Cloquintocet-mexyl, Dichlormid, Benoxacor, Flurazole and Fluxofenim and said combinations are applied preferably to corn, wheat, barley, rye, oats, rice, soybean, cotton, canola, sugar beet, potatoes, tobacco, and oil seed rape, more preferably to soybean directly or soil in which their seeds are sown.

In still another embodiment, present invention provides combinations of Metribuzin and one or more safeners selected from Mefenpyr-diethyl, Isoxadifen-ethyl, Cloquintocet-mexyl, Dichlormid, Benoxacor, Flurazole and Fluxofenim and said combinations are applied preferably to corn, wheat, barley, rye, oats, rice, soybean, cotton, canola, sugar beet, potatoes, tobacco, and oil seed rape, more preferably to soybean directly or soil in which their seeds are sown.

In still another embodiment, present invention provides combination of Metribuzin and Mefenpyr-diethyl and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in soybean.

In still another embodiment, present invention provides combination of Metribuzin and Isoxadifen-ethyl and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in soybean.

In still another embodiment, present invention provides combination of Metribuzin and Cloquintocet-mexyl and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in soybean.

In still another embodiment, present invention provides combination of Metribuzin and Dichlormid and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in soybean.

In still another embodiment, present invention provides combination of Metribuzin and Benoxacor and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in soybean.

In still another embodiment, present invention provides combination of Metribuzin and Flurazole and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in soybean.

In still another embodiment, present invention provides combination of Metribuzin and Fluxofenim and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in soybean.

In still another embodiment, present invention provides combination of Metribuzin and Mefenpyr-diethyl, wherein ratio of Metribuzin to Mefenpyr-diethyl is from 3.73:1 to 37.33:1 and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in soybean.

In still another embodiment, present invention provides combination of Metribuzin and Isoxadifen-ethyl, wherein ratio of Metribuzin to Isoxadifen-ethyl is from 2.4:1 to 24:1 and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in soybean.

In still another embodiment, present invention provides combination of Metribuzin and Cloquintocet-mexyl, wherein ratio of Metribuzin to Cloquintocet-mexyl is 84:1 and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in soybean.

In still another embodiment, present invention provides combination of Metribuzin and Dichlormid, wherein ratio of Metribuzin to Dichlormid is from from 1.90:1 to 3.81:1 and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in soybean.

In still another embodiment, present invention provides combination of Metribuzin and Benoxacor, wherein ratio of Metribuzin to Benoxacor is from 5.6:1 to 11.2:1 and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in soybean.

In still another embodiment, present invention provides combination of Metribuzin and Flurazole, wherein ratio of Metribuzin to Flurazole is from 14:1 to 140:1 and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in soybean.

In still another embodiment, present invention provides combination of Metribuzin and Fluxofenim, wherein ratio of Metribuzin to Fluxofenim is from 146:1 to 13.90:1 and said combination exhibits less or no phytotoxicity, results in increased plant height and/or increased number of plants standing after treatment, preferably in corn, wheat, barley, rye, oats, rice, soybean, cotton, canola, sugar beet, potatoes, tobacco, and oil seed rape, more preferably in soybean.

In still another embodiment, present invention provides combination of Metribuzin and Mefenpyr-diethyl, wherein Metribuzin and Mefenpyr-diethyl are applied preferably to corn, wheat, barley, rye, oats, rice, soybean, cotton, canola, sugar beet, potatoes, tobacco, and oil seed rape, more preferably to soybean, simultaneously or sequentially.

In still another embodiment, present invention provides combination of Metribuzin and Isoxadifen-ethyl, wherein Metribuzin and Isoxadifen-ethyl are applied preferably to corn, wheat, barley, rye, oats, rice, soybean, cotton, canola, sugar beet, potatoes, tobacco, and oil seed rape, more preferably to soybean, simultaneously or sequentially.

In still another embodiment, present invention provides combination of Metribuzin and Cloquintocet-mexyl, wherein Metribuzin and Cloquintocet-mexyl are applied preferably to corn, wheat, barley, rye, oats, rice, soybean, cotton, canola, sugar beet, potatoes, tobacco, and oil seed rape, more preferably to soybean, simultaneously or sequentially.

In still another embodiment, present invention provides combination of Metribuzin and Dichlormid, wherein Metribuzin and Dichlormid are applied preferably to corn, wheat, barley, rye, oats, rice, soybean, cotton, canola, sugar beet, potatoes, tobacco, and oil seed rape, more preferably to soybean, simultaneously or sequentially.

In still another embodiment, present invention provides combination of Metribuzin and Benoxacor, wherein Metribuzin and Benoxacor are applied preferably to corn, wheat, barley, rye, oats, rice, soybean, cotton, canola, sugar beet, potatoes, tobacco, and oil seed rape, more preferably to soybean, simultaneously or sequentially.

In still another embodiment, present invention provides combination of Metribuzin and Flurazole wherein Metribuzin and Flurazole are applied preferably to corn, wheat, barley, rye, oats, rice, soybean, cotton, canola, sugar beet, potatoes, tobacco, and oil seed rape, more preferably to soybean, simultaneously or sequentially.

In still another embodiment, present invention provides combination of Metribuzin and Fluxofenim wherein Metribuzin and Fluxofenim are applied preferably to corn, wheat, barley, rye, oats, rice, soybean, cotton, canola, sugar beet, potatoes, tobacco, and oil seed rape, more preferably to soybean, simultaneously or sequentially.

The combinations of one or more triazinone herbicide with one or more safeners according to the instant invention can be applied to the plants, seed of the plants and/or to the locus where the crop and weed plants are growing area under cultivation. The herbicides and safeners of said combinations can be applied simultaneously or in sequential order in both pre- as well as postemergence application.

In still another embodiment, the herbicide safener combination is formulated together and applied in pre-emergence application or post-emergence application.

In still another embodiment, the components are formulated separately and applied sequentially.

In still another embodiment, the safener is applied to the seeds or other propagation material of the crops prior to sowing or to the soil shortly after sowing in an in furrow-treatment.

In still another embodiment, the combination of one or more triazinone herbicides selected from Amibuzin, Hexazinone, Metamitron, Metribuzin, Isomethiozin, Ipfencarbazone and Ametridione and one or more safeners selected from Mefenpyr-diethyl, Isoxadifen-ethyl, Cloquintocet-mexyl, Dichlormid, Benoxacor, Flurazole and Fluxofenim is formulated together and applied in pre-emergence application or post-emergence application to preferably to corn, wheat, barley, rye, oats, rice, soybean, cotton, canola, sugar beet, potatoes, tobacco, and oil seed rape, more preferably to soybean directly or soil in which their seeds are sown.

In still another embodiment, one or more triazinone herbicides selected from Amibuzin, Hexazinone, Metamitron, Metribuzin, Isomethiozin, Ipfencarbazone and Ametridione and one or more safeners selected from Mefenpyr-diethyl, Isoxadifen-ethyl, Cloquintocet-mexyl, Dichlormid, Benoxacor, Flurazole and Fluxofenim of the herbicide safener combination are formulated separately and applied sequentially preferably to corn, wheat, barley, rye, oats, rice, soybean, cotton, canola, sugar beet, potatoes, tobacco, and oil seed rape, more preferably to soybean directly or soil in which their seeds are sown.

In still another embodiment, the safener selected from Mefenpyr-diethyl, Isoxadifen-ethyl, Cloquintocet-mexyl, Dichlormid, Benoxacor, Flurazole and Fluxofenim is applied to the seeds or other propagation material of the crops prior to sowing or to the soil shortly after sowing in an in furrow-treatment.

In still another embodiment, the combination of Metribuzin and Mefenpyr-diethyl is formulated together and applied in pre-emergence application or post-emergence application to preferably to corn, wheat, barley, rye, oats, rice, soybean, cotton, canola, sugar beet, potatoes, tobacco, and oil seed rape, more preferably to soybean directly or soil in which their seeds are sown, wherein ratio of Metribuzin and Mefenpyr-diethyl is optionally from 3.73:1 to 37.33:1.

In still another embodiment, the combination of Metribuzin and Isoxadifen-ethyl is formulated together and applied in pre-emergence application or post-emergence application to preferably to corn, wheat, barley, rye, oats, rice, soybean, cotton, canola, sugar beet, potatoes, tobacco, and oil seed rape, more preferably to soybean directly or soil in which their seeds are sown, wherein ratio of Metribuzin and Isoxadifen-ethyl is optionally from 2.4:1 to 24:1.

In still another embodiment, the combination of Metribuzin and Cloquintocet-mexyl is formulated together and applied in pre-emergence application or post-emergence application to preferably to corn, wheat, barley, rye, oats, rice, soybean, cotton, canola, sugar beet, potatoes, tobacco, and oil seed rape, more preferably to soybean directly or soil in which their seeds are sown, wherein ratio of Metribuzin and Cloquintocet-mexyl is optionally about 84:1.

In still another embodiment, the combination of Metribuzin and Dichlormid is formulated together and applied in pre-emergence application or post-emergence application to preferably to corn, wheat, barley, rye, oats, rice, soybean, cotton, canola, sugar beet, potatoes, tobacco, and oil seed rape, more preferably to soybean directly or soil in which their seeds are sown, wherein ratio of Metribuzin and Dichlormid is optionally from 1.90:1 to 3.81:1.

In still another embodiment, the combination of Metribuzin and Benoxacor is formulated together and applied in pre-emergence application or post-emergence application preferably to corn, wheat, barley, rye, oats, rice, soybean, cotton, canola, sugar beet, potatoes, tobacco, and oil seed rape, more preferably to soybean directly or soil in which their seeds are sown, wherein ratio of Metribuzin and Benoxacor is optionally from 5.6:1 to 11.2:1.

In still another embodiment, the combination of Metribuzin and Flurazole is formulated together and applied in pre-emergence application or post-emergence application preferably to corn, wheat, barley, rye, oats, rice, soybean, cotton, canola, sugar beet, potatoes, tobacco, and oil seed rape, more preferably to soybean directly or soil in which their seeds are sown, wherein ratio of Metribuzin and Flurazole is optionally from 14:1 to 140:1.

In still another embodiment, the combination of Metribuzin and Fluxofenim is formulated together and applied in pre-emergence application or post-emergence application preferably to corn, wheat, barley, rye, oats, rice, soybean, cotton, canola, sugar beet, potatoes, tobacco, and oil seed rape, more preferably to soybean directly or soil in which their seeds are sown, wherein ratio of Metribuzin and Fluxofenim is optionally from 13.90:1 to 146:1.

In still another embodiment, the combination of Metribuzin and Mefenpyr-diethyl is formulated together and applied in pre-emergence application or post-emergence application to preferably to corn, wheat, barley, rye, oats, rice, soybean, cotton, canola, sugar beet, potatoes, tobacco, and oil seed rape, more preferably to soybean directly or soil in which their seeds are sown, wherein Metribuzin is applied at the rate of 840 g ai/ha and Mefenpyr-diethyl is applied at the rate of range from 22.5 to 225 g ai/ha, preferably at 22.5 or 225 g ai/ha.

In still another embodiment, the combination of Metribuzin and Isoxadifen-ethyl is formulated together and applied in pre-emergence application or post-emergence application to preferably to corn, wheat, barley, rye, oats, rice, soybean, cotton, canola, sugar beet, potatoes, tobacco, and oil seed rape, more preferably to soybean directly or soil in which their seeds are sown, wherein Metribuzin is applied at the rate of 840 g ai/ha and Isoxadifen-ethyl is applied at the rate of range from 35 to 350 g ai/ha, preferably at 35 or 350 g ai/ha.

In still another embodiment, the combination of Metribuzin and Cloquintocet-mexyl is formulated together and applied in pre-emergence application or post-emergence application to preferably to corn, wheat, barley, rye, oats, rice, soybean, cotton, canola, sugar beet, potatoes, tobacco, and oil seed rape, more preferably to soybean directly or soil in which their seeds are sown, wherein Metribuzin is applied at the rate of 840 g ai/ha and Cloquintocet-mexyl is applied at the rate of 10.1 g ai/ha.

In still another embodiment, the combination of Metribuzin and Dichlormid is formulated together and applied in pre-emergence application or post-emergence application to preferably to corn, wheat, barley, rye, oats, rice, soybean, cotton, canola, sugar beet, potatoes, tobacco, and oil seed rape, more preferably to soybean directly or soil in which their seeds are sown, wherein Metribuzin is applied at the rate of 840 g ai/ha and Dichlormid is applied at the rate of range from 220 to 440 g ai/ha, preferably at 220 or 440 g ai/ha.

In still another embodiment, the combination of Metribuzin and Benoxacor is formulated together and applied in pre-emergence application or post-emergence application preferably to corn, wheat, barley, rye, oats, rice, soybean, cotton, canola, sugar beet, potatoes, tobacco, and oil seed rape, more preferably to soybean directly or soil in which their seeds are sown, wherein Metribuzin is applied at the rate of 840 g ai/ha and Benoxacor is applied at the rate of range from 75 to 150 g ai/ha, preferably at 75 or 150 g ai/ha.

In still another embodiment, the combination of Metribuzin and Flurazole is formulated together and applied in pre-emergence application or post-emergence application preferably to corn, wheat, barley, rye, oats, rice, soybean, cotton, canola, sugar beet, potatoes, tobacco, and oil seed rape, more preferably to soybean directly or soil in which their seeds are sown, wherein Metribuzin is applied at the rate of 840 g ai/ha and Flurazole is applied at the rate of range from 6 to 60 g ai/ha, preferably at 6 or 60 g ai/ha.

In still another embodiment, the combination of Metribuzin and Fluxofenim is formulated together and applied in pre-emergence application or post-emergence application preferably to corn, wheat, barley, rye, oats, rice, soybean, cotton, canola, sugar beet, potatoes, tobacco, and oil seed rape, more preferably to soybean directly or soil in which their seeds are sown, wherein Metribuzin is applied at the rate of 840 g ai/ha and Fluxofenim is applied at the rate of range from 5.75 to 60.4 g ai/ha, preferably at 5.75 or 60.4 g ai/ha.

The herbicide safener compositions of the present invention can reduce phytotoxicity of triazinone herbicides and therefore provide selective control of weeds.

As will be demonstrated in the examples, the combinations of one or more triazinone herbicides with one or more safeners reduced phytotoxicity of herbicides, resulted in increased height of plants and/or increased number of plants standing after treatments.

These and other advantages of the invention may become more apparent from the examples set forth herein below. These examples are provided merely as illustrations of the invention and are not intended to be construed as a limitation thereof.

### Examples

Experiments were carried out to evaluate the phytotoxicity, effect on plant height and effect on number of plants standing after treatments with combinations of one or more triazinone herbicides with one or more safeners.

Below table gives summary of the formulation details and application details of Metribuzin and Mefenpyr-diethyl, Isoxadifen-ethyl and Cloquintocet-mexyl that were used in combination with Metribuzin for treatments. Application method was spray and applications were made to soil.

TABLE 1

| Treatment | Treatment | Formulation | Application |
|---|---|---|---|
| Number | Components | Details | details |
| 1. | Untreated Check | — | — |
| 2. | Metribuzin | 480 g/L SC | 840 g ai/ha |
| 3. | Metribuzin + | 480 g/L SC + 450 | 840 g ai/ha + 22.5 g |
| | Mefenpyr-diethyl | g/L EC | ai/ha |
| 4. | Metribuzin + | 480 g/L SC + 450 | 840 g ai/ha + 225 g |
| | Mefenpyr-diethyl | g/L EC | ai/ha |
| 5. | Metribuzin + | 480 g/L SC + 82 | 840 g ai/ha + 35 g |
| | Isoxadifen-ethyl | g/L EC | ai/ha |
| 6. | Metribuzin + | 480 g/L SC + 82 | 840 g ai/ha + 350 g |
| | Isoxadifen-ethyl | g/L EC | ai/ha |
| 7. | Metribuzin + | 480 g/L SC + 160 | 840 g ai/ha + 10.1 g |
| | Cloquintocet-mexyl | g/L EC | ai/ha |
| 8. | Metribuzin + | 480 g/L SC + 160 | 840 g ai/ha + 100 g |
| | Cloquintocet-mexyl | g/L EC | ai/ha |

Below table gives summary of the formulation details and application details of Metribuzin and Dichlormid, Fenclorim, Benoxacor, Flurazole and Fluxofenim that were used in combination with Metribuzin for treatments. Application method was spray and applications were made to soil.

TABLE 2

| Treatment | Treatment | Formulation | Application |
|---|---|---|---|
| Number | Components | Details | details |
| 9. | Untreated Check | — | — |
| 10. | Metribuzin | 480 g/L SC | 840 g ai/ha |
| 11. | Metribuzin + | 480 g/L SC + 450 | 840 g ai/ha + 220 g |
| | Dichlormid | g/L EC | ai/ha |
| 12. | Metribuzin + | 480 g/L SC + 450 | 840 g ai/ha + 440 g |
| | Dichlormid | g/L EC | ai/ha |
| 13. | Metribuzin + | 480 g/L SC + 220 | 840 g ai/ha + 150 g |
| | Fenclorim | g/L EC | ai/ha |
| 14. | Metribuzin + | 480 g/L SC + 220 | 840 g ai/ha + 300 g |
| | Fenclorim | g/L EC | ai/ha |
| 15. | Metribuzin + | 480 g/L SC + 160 | 840 g ai/ha + 75 g |
| | Benoxacor | g/L EC | ai/ha |
| 16. | Metribuzin + | 480 g/L SC + 160 | 840 g ai/ha + 150 g |
| | Benoxacor | g/L EC | ai/ha |
| 17. | Metribuzin + | 480 g/L SC + 400 | 840 g ai/ha + 6 g |
| | Flurazole | g/L EC | ai/ha |
| 18. | Metribuzin + | 480 g/L SC + 400 | 840 g ai/ha + 60 g |
| | Flurazole | g/L EC | ai/ha |
| 19. | Metribuzin + | 480 g/L SC + 958 | 840 g ai/ha + 5.75 g |
| | Fluxofenim | g/L EC | ai/ha |
| 20. | Metribuzin + | 480 g/L SC + 958 | 840 g ai/ha + 60.4 g |
| | Fluxofenim | g/L EC | ai/ha |

Below table gives summary of % weed control in Soybean crop shown by untreated check, Metribuzin alone and combination of Metribuzin with Mefenpyr-diethyl, Isoxadifen-ethyl and Cloquintocet-mexyl at different application rates. % weed control was checked for weed Ipomoea hederacea.

TABLE 3

| | | | % Weed Control | | | | |
|---|---|---|---|---|---|---|---|
| Treatment | Treatment | Application | 7 | 14 | 21 | 28 | 35 |
| Number | Components | details | DAA * | DAA * | DAA * | DAA * | DAA * |
| 1. | Untreated | — | 0 | 0 | 0 | 0 | 0 |
| | Check | | | | | | |
| 2. | Metribuzin | 840 g ai/ha | 60.0 | 92.5 | 98.8 | 95.0 | 96.3 |
| 3. | Metribuzin + | 840 g ai/ha + | 57.5 | 87.5 | 98.8 | 100.0 | 100.0 |
| | Mefenpyr- | 22.5 g ai/ha | | | | | |
| | diethyl | | | | | | |
| 4. | Metribuzin + | 840 g ai/ha + | 47.5 | 92.5 | 96.3 | 100.0 | 100.0 |
| | Mefenpyr- | 225 g ai/ha | | | | | |
| | diethyl | | | | | | |
| 5. | Metribuzin + | 840 g ai/ha + | 50.0 | 87.5 | 88.3 | 96.3 | 96.3 |
| | Isoxadifen- | 35 g ai/ha | | | | | |
| | ethyl | | | | | | |
| 6. | Metribuzin + | 840 g ai/ha + | 50.0 | 87.5 | 97.5 | 98.0 | 98.0 |
| | Isoxadifen- | 350 g ai/ha | | | | | |
| | ethyl | | | | | | |
| 7. | Metribuzin + | 840 g ai/ha + | 60.0 | 96.3 | 98.8 | 100.0 | 100.0 |
| | Cloquintocet- | 10.1 g ai/ha | | | | | |
| | mexyl | | | | | | |
| 8. | Metribuzin + | 840 g ai/ha + | 50.0 | 95.0 | 100.0 | 100.0 | 100.0 |
| | Cloquintocet- | 100 g ai/ha | | | | | |
| | mexyl | | | | | | |

* DAA—Days after administration. All the values for % weed control in table above are average of 4 replications.

Below table gives summary of % weed control in Soybean crop shown by untreated check, Metribuzin alone and combination of Metribuzin with Dichlormid, Fenclorim, Benoxacor, Flurazole and Fluxofenim at different application rates. % weed control was checked for weed Ipomoea hederacea.

TABLE 4

| | | | % Weed Control | | | | |
|---|---|---|---|---|---|---|---|
| Treatment | Treatment | Application | 7 | 14 | 21 | 28 | 35 |
| Number | Components | details | DAA * | DAA * | DAA * | DAA * | DAA * |
| 9. | Untreated | — | 0 | 0 | 0 | 0 | 0 |
| | Check | | | | | | |
| 10. | Metribuzin | 840 g ai/ha | 72.5 | 96.3 | 96.8 | 98.8 | 98.8 |
| 11. | Metribuzin + | 840 g ai/ha + | 72.5 | 93.8 | 96.3 | 100.0 | 100.0 |
| | Dichlormid | 220 g ai/ha | | | | | |
| 12. | Metribuzin + | 840 g ai/ha + | 62.5 | 96.3 | 97.5 | 97.5 | 97.5 |
| | Dichlormid | 440 g ai/ha | | | | | |
| 13. | Metribuzin + | 840 g ai/ha + | 72.5 | 100.0 | 97.5 | 98.8 | 98.8 |
| | Fenclorim | 150 g ai/ha | | | | | |
| 14. | Metribuzin + | 840 g ai/ha + | 77.5 | 97.5 | 100.0 | 100.0 | 100.0 |
| | Fenclorim | 300 g ai/ha | | | | | |
| 15. | Metribuzin + | 840 g ai/ha + | 60.0 | 93.8 | 98.8 | 98.8 | 98.8 |
| | Benoxacor | 75 g ai/ha | | | | | |
| 16. | Metribuzin + | 840 g ai/ha + | 55.0 | 88.8 | 91.3 | 91.3 | 91.3 |
| | Benoxacor | 150 g ai/ha | | | | | |
| 17. | Metribuzin + | 840 g ai/ha + | 62.5 | 97.5 | 98.8 | 100.0 | 100.0 |
| | Flurazole | 6 g ai/ha | | | | | |
| 18. | Metribuzin + | 840 g ai/ha + | 73.8 | 91.3 | 93.8 | 90.0 | 90.0 |
| | Flurazole | 60 g ai/ha | | | | | |
| 19. | Metribuzin + | 840 g ai/ha + | 55.0 | 97.5 | 100.0 | 100.0 | 100.0 |
| | Fluxofenim | 5.75 g ai/ha | | | | | |
| 20. | Metribuzin + | 840 g ai/ha + | 56.3 | 90.0 | 91.3 | 92.5 | 92.5 |
| | Fluxofenim | 60.4 g ai/ha | | | | | |

* DAA—Days after administration. All the values for % weed control in table above are average of 4 replications.

Below table gives summary of % phytotoxicity in Soybean crop shown by untreated check, Metribuzin alone and combination of Metribuzin with Mefenpyr-diethyl, Isoxadifen-ethyl and Cloquintocet-mexyl at different application rates.

TABLE 5

| | | | % Phytotoxicity | | | | |
|---|---|---|---|---|---|---|---|
| Treatment | Treatment | Application | 7 | 14 | 21 | 28 | 35 |
| Number | Components | details | DAA * | DAA * | DAA * | DAA * | DAA * |
| 1. | Untreated | — | 0 | 0 | 0 | 0 | 0 |
| | Check | | | | | | |
| 2. | Metribuzin | 840 g ai/ha | 6.3 | 51.3 | 65.0 | 76.3 | 81.3 |
| 3. | Metribuzin + | 840 g ai/ha + | 5.0 | 42.5 | 42.5 | 43.8 | 43.8 |
| | Mefenpyr- | 22.5 g ai/ha | | | | | |
| | diethyl | | | | | | |
| 4. | Metribuzin + | 840 g ai/ha + | 10.0 | 18.8 | 23.8 | 27.5 | 27.5 |
| | Mefenpyr- | 225 g ai/ha | | | | | |
| | diethyl | | | | | | |
| 5. | Metribuzin + | 840 g ai/ha + | 5.0 | 40.0 | 43.8 | 48.8 | 53.8 |
| | Isoxadifen- | 35 g ai/ha | | | | | |
| | ethyl | | | | | | |
| 6. | Metribuzin + | 840 g ai/ha + | 17.5 | 41.3 | 47.5 | 56.3 | 57.5 |
| | Isoxadifen- | 350 g ai/ha | | | | | |
| | ethyl | | | | | | |
| 7. | Metribuzin + | 840 g ai/ha + | 27.5 | 46.3 | 46.3 | 56.3 | 61.3 |
| | Cloquintocet- | 10.1 g ai/ha | | | | | |
| | mexyl | | | | | | |
| 8. | Metribuzin + | 840 g ai/ha + | 17.5 | 53.8 | 60.0 | 68.8 | 72.5 |
| | Cloquintocet- | 100 g ai/ha | | | | | |
| | mexyl | | | | | | |

* DAA—Days after administration. All the values for % phytotoxicity in table above are average of 4 replications.

It is evident from above table that combinations of Metribuzin with Mefenpyr-diethyl at both application rates and Isoxadifen-ethyl at both application rates and Cloquintocet-mexyl at lower rate resulted in less phytotoxicity as compared to single Metribuzin treatment except after 7 days of administration.

Below table gives summary of % phytotoxicity in Soybean crop shown by untreated check, Metribuzin alone and combination of Metribuzin with Dichlormid, Fenclorim, Benoxacor, Flurazole and Fluxofenim at different application rates.

TABLE 6

| | | | % Phytotoxicity | | | | |
|---|---|---|---|---|---|---|---|
| Treatment | Treatment | Application | 7 | 14 | 21 | 28 | 35 |
| Number | Components | details | DAA * | DAA * | DAA * | DAA * | DAA * |
| 9. | Untreated | — | 0 | 0 | 0 | 0 | 0 |
| | Check | | | | | | |
| 10. | Metribuzin | 840 g ai/ha | 7.5 | 48.8 | 62.5 | 68.8 | 72.5 |
| 11. | Metribuzin + | 840 g ai/ha + | 6.3 | 45.0 | 53.8 | 56.3 | 60.0 |
| | Dichlormid | 220 g ai/ha | | | | | |
| 12. | Metribuzin + | 840 g ai/ha + | 5.0 | 47.5 | 47.5 | 51.3 | 52.5 |
| | Dichlormid | 440 g ai/ha | | | | | |
| 13. | Metribuzin + | 840 g ai/ha + | 5.0 | 56.3 | 71.3 | 76.3 | 76.3 |
| | Fenclorim | 150 g ai/ha | | | | | |
| 14. | Metribuzin + | 840 g ai/ha + | 7.5 | 57.5 | 78.8 | 83.8 | 85.0 |
| | Fenclorim | 300 g ai/ha | | | | | |
| 15. | Metribuzin + | 840 g ai/ha + | 4.8 | 46.8 | 60.0 | 65.0 | 68.8 |
| | Benoxacor | 75 g ai/ha | | | | | |
| 16. | Metribuzin + | 840 g ai/ha + | 7.5 | 50.0 | 55.0 | 58.8 | 60.0 |
| | Benoxacor | 150 g ai/ha | | | | | |
| 17. | Metribuzin + | 840 g ai/ha + | 6.3 | 47.5 | 53.8 | 61.3 | 61.3 |
| | Flurazole | 6 g ai/ha | | | | | |
| 18. | Metribuzin + | 840 g ai/ha + | 6.3 | 41.3 | 41.3 | 47.5 | 52.5 |
| | Flurazole | 60 g ai/ha | | | | | |
| 19. | Metribuzin + | 840 g ai/ha + | 4.8 | 40.0 | 42.5 | 35.0 | 45.0 |
| | Fluxofenim | 5.75 g ai/ha | | | | | |
| 20. | Metribuzin + | 840 g ai/ha + | 4.3 | 42.5 | 46.3 | 61.3 | 68.8 |
| | Fluxofenim | 60.4 g ai/ha | | | | | |

* DAA—Days after administration. All the values for % phytotoxicity in table above are average of 4 replications.

It is evident from above table that combinations of Metribuzin with Dichlormid at both application rates, Flurazole at both application rates, Fluxofenim at both application rates, Benoxacor at both rates exhibited less phytotoxicity as compared to single Metribuzin treatment.

Combinations of Metribuzin with Fenclorim at both rates resulted in more phytotoxicity as compared to single Metribuzin treatment.

Below table gives summary of effect on plant height of Soybean crop shown by untreated check, Metribuzin alone and combination of Metribuzin with Mefenpyr-diethyl, Isoxadifen-ethyl and Cloquintocet-mexyl at different application rates.

TABLE 7

| Treatment | Treatment | Application | Plant height |
|---|---|---|---|
| Number | Components | details | 28 DAA* |
| 1. | Untreated Check | — | 12.10 |
| 2. | Metribuzin | 840 g ai/ha | 5.80 |
| 3. | Metribuzin + | 840 g ai/ha + 22.5 g | 10.90 |
| | Mefenpyr-diethyl | ai/ha | |
| 4. | Metribuzin + | 840 g ai/ha + 225 g | 10.75 |
| | Mefenpyr-diethyl | ai/ha | |
| 5. | Metribuzin + | 840 g ai/ha + 35 g | 9.63 |
| | Isoxadifen-ethyl | ai/ha | |
| 6. | Metribuzin + | 840 g ai/ha + 350 g | 7.30 |
| | Isoxadifen-ethyl | ai/ha | |
| 7. | Metribuzin + | 840 g ai/ha + 10.1 g | 7.45 |
| | Cloquintocet-mexyl | ai/ha | |
| 8. | Metribuzin + | 840 g ai/ha + 100 g | 4.60 |
| | Cloquintocet-mexyl | ai/ha | |

*DAA—Days after administration.
All the values for plant height in table above are average of 4 replications.

It is evident from above table that Metribuzin with Mefenpyr-diethyl at both application rates, Isoxadifen-ethyl at both application rates and Cloquintocet-mexyl at lower application rate resulted in an increase in plant height as compared Metribuzin alone. Combination of Metribuzin with Cloquintocet-mexyl at higher application rate resulted in a decrease in plant height as compared Metribuzin alone.

Below table gives summary of effect on plant height of Soybean crop shown by untreated check, Metribuzin alone and combination of Metribuzin with Dichlormid, Fenclorim, Fenclorim, Benoxacor and Fluxofenim at different application rates.

TABLE 8

| Treatment | Treatment | Application | Plant Height |
|---|---|---|---|
| Number | Components | details | 28 DAA* |
| 1. | Untreated Check | — | 11.10 |
| 2. | Metribuzin | 840 g ai/ha | 7.05 |
| 3. | Metribuzin + | 840 g ai/ha + 220 g | 7.20 |
| | Dichlormid | ai/ha | |
| 4. | Metribuzin + | 840 g ai/ha + 440 g | 9.78 |
| | Dichlormid | ai/ha | |
| 5. | Metribuzin + | 840 g ai/ha + 150 g | 5.25 |
| | Fenclorim | ai/ha | |
| 6. | Metribuzin + | 840 g ai/ha + 300 g | 4.60 |
| | Fenclorim | ai/ha | |
| 7. | Metribuzin + | 840 g ai/ha + 75 g | 7.65 |
| | Benoxacor | ai/ha | |
| 8. | Metribuzin + | 840 g ai/ha + 150 g | 8.88 |
| | Benoxacor | ai/ha | |
| 9. | Metribuzin + | 840 g ai/ha + 6 g | 7.75 |
| | Flurazole | ai/ha | |
| 10. | Metribuzin + | 840 g ai/ha + 60 g | 10.00 |
| | Flurazole | ai/ha | |
| 11. | Metribuzin + | 840 g ai/ha + 5.75 g | 11.40 |
| | Fluxofenim | ai/ha | |
| 12. | Metribuzin + | 840 g ai/ha + 60.4 g | 9.28 |
| | Fluxofenim | ai/ha | |

*DAA—Days after administration
All the values for plant height in table above are average of 4 replications.

It is evident from above table that Metribuzin with Dichlormid at both application rates, Benoxacor at both application rates, Flurazole at both application rates and Fluxofenim at both application rates resulted in increase in plant height as compared Metribuzin alone. Combination of Metribuzin with Fenchlorim at both application rates resulted in a decrease in plant height as compared Metribuzin alone.

Below table gives summary of effect on number of standing Soybean plants shown by untreated check, Metribuzin alone and combination of Metribuzin with Mefenpyr-diethyl, Isoxadifen-ethyl and Cloquintocet-mexyl at different application rates.

TABLE 9

| | | | Number of plants |
|---|---|---|---|
| Treatment | Treatment | Application | standing |
| Number | Components | details | 28 DAA* |
| 1. | Untreated Check | — | 6.0 |
| 2. | Metribuzin | 840 g ai/ha | 3.0 |
| 3. | Metribuzin + | 840 g ai/ha + 22.5 g | 6.0 |
| | Mefenpyr-diethyl | ai/ha | |
| 4. | Metribuzin + | 840 g ai/ha + 225 g | 6.8 |
| | Mefenpyr-diethyl | ai/ha | |
| 5. | Metribuzin + | 840 g ai/ha + 35 g | 5.8 |
| | Isoxadifen-ethyl | ai/ha | |
| 6. | Metribuzin + | 840 g ai/ha + 350 g | 3.5 |
| | Isoxadifen-ethyl | ai/ha | |
| 7. | Metribuzin + | 840 g ai/ha + 10.1 g | 4.3 |
| | Cloquintocet-mexyl | ai/ha | |
| 8. | Metribuzin + | 840 g ai/ha + 100 g | 2.3 |
| | Cloquintocet-mexyl | ai/ha | |

*DAA—Days after administration.
All the values for number of standing plants in table above are average of 4 replications.

It is evident from above table that Metribuzin with Mefenpyr-diethyl at both application rates, Isoxadifen-ethyl at both application rates and Cloquintocet-mexyl at lower application rate resulted in an increase in number of plants standing as compared Metribuzin alone. Combination of Metribuzin with Cloquintocet-mexyl at higher application rate resulted in a decrease in number of plants standing as compared Metribuzin alone.

Below table gives summary of effect on number of standing Soybean plants shown by untreated check, Metribuzin alone and combination of Metribuzin with Dichlormid, Fenclorim, Benoxacor, Flurazole and Fluxofenim at different application rates.

TABLE 10

| | | | Number of plants |
|---|---|---|---|
| Treatment | Treatment | Application | standing |
| Number | Components | details | 28 DAA* |
| 1. | Untreated Check | — | 5.5 |
| 2. | Metribuzin | 840 g ai/ha | 3.8 |
| 3. | Metribuzin + | 840 g ai/ha + 220 g | 3.3 |
| | Dichlormid | ai/ha | |
| 4. | Metribuzin + | 840 g ai/ha + 440 g | 4.0 |
| | Dichlormid | ai/ha | |
| 5. | Metribuzin + | 840 g ai/ha + 150 g | 2.3 |
| | Fenclorim | ai/ha | |
| 6. | Metribuzin + | 840 g ai/ha + 300 g | 2.3 |
| | Fenclorim | ai/ha | |
| 7. | Metribuzin + | 840 g ai/ha + 75 g | 3.8 |
| | Benoxacor | ai/ha | |
| 8. | Metribuzin + | 840 g ai/ha + 150 g | 4.0 |
| | Benoxacor | ai/ha | |
| 9. | Metribuzin + | 840 g ai/ha + 6 g | 3.8 |
| | Flurazole | ai/ha | |
| 10. | Metribuzin + | 840 g ai/ha + 60 g | 5.3 |
| | Flurazole | ai/ha | |
| 11. | Metribuzin + | 840 g ai/ha + 5.75 g | 8.5 |
| | Fluxofenim | ai/ha | |
| 12. | Metribuzin + | 840 g ai/ha + 60.4 g | 5.0 |
| | Fluxofenim | ai/ha | |

*DAA—Days after administration.
All the values for number of standing plants in table above are average of 4 replications.

It is evident from above table that Metribuzin with Dichlormid at both application rates, Benoxacor at both application rates, Flurazole at both application rates and Fluxofenim at both application rates resulted in increase in number of plants standing as compared Metribuzin alone. Combination of Metribuzin with Fenchlorim at both application rates resulted in a decrease in number of plants standing as compared Metribuzin alone.

1. A herbicide combination comprising:
a. one or more triazinone herbicides and
b. at least one safener.

2. The combination as claimed in claim 1, wherein said safener is selected from mefenpyr-diethyl, isoxadifen-ethyl, cloquintocet-mexyl, dichlormid, benoxacor, fenclorim, flurazole, fluxofenim, and combinations thereof.

3. A method of controlling weeds at a locus comprising applying herbicide combination of one or more triazinone herbicides and at least one safener to the locus.
